(19) United States
(12) Patent Application Publication
(10) Pub. No.: US 2004/0204082 A1
(43) Pub. Date: Oct. 14, 2004

(54) Mobile financial card scanner using a wireless digital network to transmit the transaction of the purchase of goods and services

(75) Inventor: Marcos Abeyta, Albuquerque, NM (US)

Correspondence Address: SCULLY SCOTT MURPHY & PRESSER, PC, 400 GARDEN CITY PLAZA, GARDEN CITY, NY, 11530

(73) Assignee: International Business Machines Corporation, Armonk, NY

(21) Appl. No.: 10/337,656

(22) Filed: Jan. 7, 2003

(51) Int. Cl. H04M 1/00

(52) U.S. Cl. 455/557; 455/556.1

(57) ABSTRACT

A method and system of transmitting financial transaction information. The method comprises the steps of using a mobile financial card scanner to scan a financial card to read information therefrom, transmitting the information from the card scanner to a digital mobile phone, and using the digital phone to transmit said information, as digital data, over a wireless digital network, to a remote financial authority. Preferably, the digital phone is able to encrypt and decrypt data, so that all of the data transmitted between the phone and the financial authority can be in an encrypted form.

### BACKGROUND OF THE INVENTION

1. Field of the Invention

This invention generally relates to financial transaction processing and authorization. More specifically, the invention relates to wireless data communications and data security for financial transaction processing.

2. Background Art

A business or merchant may want to accept credit cards or debit cards as payment for goods and services in addition to accepting cash payments. However, acceptance of a credit or debit card as payment requires that the merchant verify that the credit card is valid and that a charge submitted by the merchant to the issuer of the credit or debit card will be accepted by the issuing organization.

Early charge authorization systems required the merchant to place a phone call to an authorization center, which asked the merchant for the number of the credit card, the identification number for the merchant, the amount of the transaction and other such information. The authorization center then used a computer system to verify that the charge was authorized and then provided the merchant with an identifying authorization number. The merchant then submitted the charge to the credit card issuing organization, usually through the merchant's banking institution, on a paper transaction slip. The authorization number was included, along with written information on the amount of the transaction, the credit card number and the merchant identification number on this paper transaction slip. Usually the customer was also provided with a copy of the transaction slip.

Drawbacks of these early systems included the heavy reliance on paper transaction slips and their inherent high cost and the amount of human labor involved in the transaction authorization process. To overcome these drawbacks, later systems for credit card transaction authorization have used electronic point-of-sale terminals that automatically obtain an authorization or denial of a credit card transaction.

These point-of-sale terminals typically read a magnetic stripe on the credit card to obtain the credit card number and expiration date and use a keypad for merchant entry of the amount of the charge. The point-of-sale terminal then automatically makes a connection with an authorization processor via a dial-up phone line and the public switched telephone network. The point-of-sale terminal transmits information about the desired transaction to the authorization processor. The authorization processor obtains, from the credit or debit card issuing organization, an authorization or denial of the desired transaction. The authorization processor then transmits information indicative of the authorization or denial of the transaction to the point-of-sale terminal. The point-of-sale terminal then usually displays an authorization code number and also presents a receipt for the customer to sign.

Automated teller machines are another type of financial transaction device that uses a dial-up telephone line and the public switched telephone system to contact an authorization processor to obtain an authorization or denial of a financial transaction.

In addition to obtaining authorization to make a charge to a credit or debit card, merchants have also used these point-of-sale terminals as check verification systems. In this case, the desired financial transaction is a check verification, and the point-of-sale terminal contacts an authorization processor, which is used to obtain an authorization or denial of the acceptance of the customer's check.

A disadvantage of these types of financial transaction devices is that they require a dial-up phone line connected to the public switched telephone network in order to contact the authorization processor. This requirement precludes the use of these devices in a portable fashion, unless a dialup phone line is available at each location where the financial transaction device will be used.

Merchants who would like to accept credit or debit cards but who have mobile or temporary locations, such as taxicabs, roadside stand vendors, pizza delivery companies, or other mobile vendors do not always have a dial-up phone line available to them at their mobile or temporary locations. Thus, these merchants cannot use these conventional point-of-sale transaction terminals.

Another disadvantage of some of these devices is that the communications between the point-of-sale terminal and the authorization processor are undertaken with the credit card number, cardholder name and other data in plaintext without encoding or efforts to hide these data. The signals transmitted by the point-of-sale terminal may travel dozens or hundreds of miles to the authorization processor. An electronic device that picks up signals off the dial-up phone line anywhere along the length of the transmission path may be able to obtain the cardholder name, credit card number, expiration date and other information since these data are transmitted in plaintext.

Wireless operation of a financial transaction device in a portable fashion would allow merchants who are currently not capable of accepting credit or debit cards as payment for goods or services to accept such cards. Additional benefits may be provided to merchants if the wireless connection of a financial transaction device either provided cost savings to the merchant or provided backup services in the case of a dial-up phone line failure. Adding wireless capabilities to an existing financial transaction device further provides a merchant with the option of operating the financial transaction device in either a fixed or portable fashion, as determined to be most beneficial to the merchant.

### SUMMARY OF THE INVENTION

An object of this invention is to improve methods and systems for wireless financial transactions.

Another object of this invention is to provide a mobile credit card scanner using a wireless digital network to transmit the transaction of a purchase of goods and services.

A further object of the invention is to couple a credit card scanner to a digital mobile phone to enable a portability of the credit card scanner and value added security.

These and other objects are attained with a method and system of transmitting financial transaction information. The method comprises the steps of using a mobile financial card scanner to scan a financial card to read information therefrom, transmitting the information from the card scanner to a digital mobile phone, and using the digital phone to transmit said information, as digital data, over a wireless digital network, to a remote financial authority. Preferably, the digital phone is able to encrypt and decrypt data, so that all of the data transmitted between the phone and the financial authority can be in an encrypted form.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a wireless system for processing financial transactions.

FIG. 2 is a block diagram showing details of the credit card terminal of the system of FIG. 1.

FIG. 3 is a block diagram showing details of the digital phone of the system of FIG. 1.

### DETAILED DESCRIPTION OF THE PREFERRED EMBODIMENTS

A financial transaction device may, for example, be a point-of-sale credit card terminal, a point-of-sale debit card terminal, a point-of-sale check authorization terminal, a smart card terminal, a computerized cash register, or an automated teller machine. Each of these devices accepts a credit card, a debit card, a smart card or operator input indicative of a financial transaction, and executes a financial transaction that includes obtaining an authorization of the validity or acceptance of the desired transaction. The credit card, debit card, or checking account number, expiration date, cardholder name and other information may either be entered into the financial transaction device by a human operator entering the data manually, by the financial transaction device reading the identifying data from a magnetic stripe located on the credit or debit card, or by electronically reading data from a smart card.

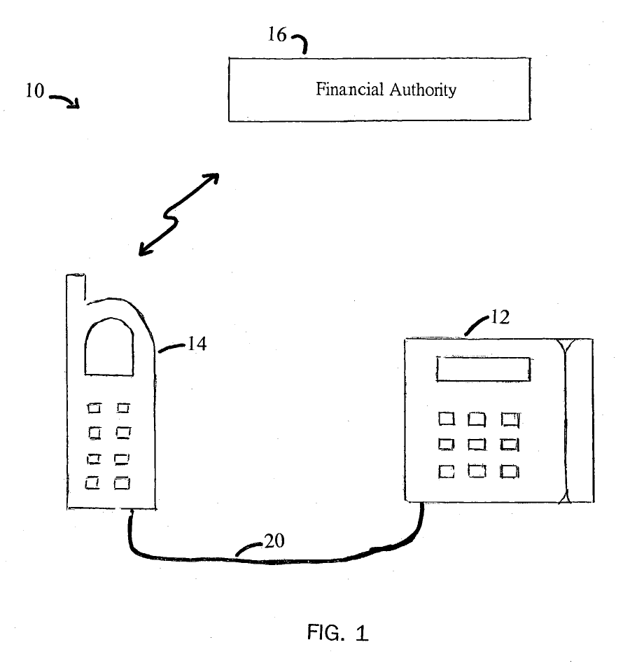

FIG. 1 illustrates, as an example, a wireless financial transaction processing system 10 comprising transaction device 12, digital portable phone 14, and financial institution or authorizing agency 16. Generally, device 12, which may be a point-of-sale credit card terminal, receives data in the course of a transaction offer, and these data are sent to digital phone 14. Phone 14 receives this data and transmits data to authorizing agency 16. That agency then receives and processes the data and sends a response back to phone 14. This response, typically, indicates whether the proposed transaction is acceptable or not acceptable, although other or additional information may also be sent to the phone 14. On the basis of the received response, the proposed transaction is accepted or rejected, although other or additional actions may also be taken.

The data transmitted between phone 14 and agency 16 are in the form of digital data, and the data are transmitted via a wireless digital network. The data transmitted between phone 14 and terminal 12 typically are in the form of analog data transmitted via wire or cable 20. It should be noted, though, that the transmission of data between phone 14 and terminal 12 could be wireless, for instance, via infrared signals, and digital data could also be transmitted between phone 14 and terminal 12.

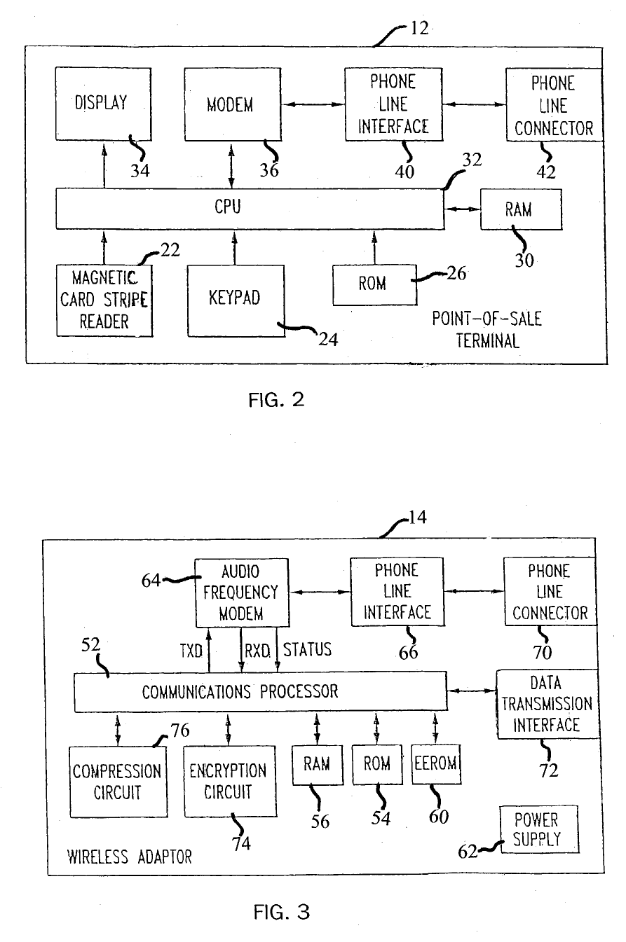

As shown in FIG. 2, credit card terminal 12 has a magnetic card stripe reader 22, a keypad 24, a read-only memory (ROM) 26 for storage of one or more programs, a random access memory 30 (RAM) for data storage, a central processing unit (CPU) 32, a display 34, a modem 36, a phone line interface 40 and a phone line connector 42. The display 34 is a display unit that is capable of displaying alphanumeric characters, and the keypad 24 is used by an operator to enter numeric or alphanumeric data. The magnetic card stripe reader 22 is used to read information from a magnetic stripe (not shown) on a credit or debit card (also not shown), and the phone line connector 42 is normally used to provide a phone line connection to the public switched telephone network. When the digital phone 14 of system 10 is used with the terminal 12, then the phone line connector 42 is used to connect the terminal to this digital phone

The operation of the terminal 12 will now be described. The merchant receives a credit card from a customer who wishes to use the credit card as payment for the goods and/or services of the merchant. The merchant swipes the credit card through the magnetic card stripe reader 22 of the terminal 12, so that the CPU 32 reads the credit card number, expiration date and other information that may be available on the magnetic stripe located on the credit card. The merchant then uses the keypad 24 of the terminal to enter the amount of the purchase and any other information needed to specify the type of transaction.

With reference to FIG. 3, the digital mobile phone 14 of system 10 preferably comprises communications processor 52, ROM 54, RAM 56, EEROM 60, power supply 62, audio frequency modem 64, phone line interface 66, phone line connector 70, and data transmission interface 72. Preferably, digital mobile phone 14 also includes encryption circuit 74 and compression circuit 76.

The communications processor 52 of phone 14 may be a conventional CPU or microcontroller, connected to ROM 54 and RAM 56 by busses in a conventional fashion. Dynamic RAM may be used for RAM 56, and Flash ROM may be used for the ROM 54.

The audio frequency modem 64 is coupled to the communications processor 52 by conventional means, such as a TXD signal line, an RXD signal line and a STATUS signal line. In use, the audio frequency modem 64 receives digital data that are to be converted into audio frequency signals on the TXD signal line, and transmits digital signals that are recovered from audio frequency signals on the RXD signal line. Most audio frequency modems also have a STATUS output signal line that provides a status signal that indicates if the audio frequency modem is currently receiving a carrier from another audio frequency modem.

The phone line connector 70 is used to connect phone 14 to cable 20, and to receive signals from and to transmit signals to terminal 12 via the cable. Interface 66 is functionally located between and operates to couple together connector 70 and modem 64.

Encryption circuit 74 is coupled to communications processor 52. Data that are to be encrypted are transmitted from communications processor 52 to encryption circuit 74, and the encrypted data are transmitted from the encryption circuit to communications processor 52. Encryption circuit 74 may also be used to decrypt data that communications processor 52 receives.

Compression circuit 76 is coupled to communications processor 52. Data that are to be compressed are transmitted from communications processor 52 to compression circuit 76, and the compressed data are transmitted from compression circuit 76 to communications processor 52. Compression circuit 76 may also be used to decompress data that communications processor 52 receives.

It should be noted that the circuits and processes shown in FIG. 2, except for the magnetic card strip reader 22, may also be accomplished in the circuitry and software of the digital phone 14. Thus, the digital phone may be able to accomplish virtually all of the activities usually done by conventional POS terminals except the reading of the card's magnetic strip.

Also, much of the data transmission by the wireless network, and the software used for such purpose, may be web based. Many wireless digital phones contain web browsers and some contain enhanced software for making purchases. Thus, the software for the transaction process and the software contained in the digital phone preferably are both html and java capable. By including the html and java features, the transaction process is enhanced, along with increased flexibility regarding data transmission protocols and web data transmission standards.

In addition, preferably, the present invention may be used in or with a is a private automatic branch exchange (PABX), or in or with an automatic telephone switching system within a private enterprise or a proprietary telephone network, which may be wireless.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A mobile system to transmit financial transaction information, comprising
a mobile financial card scanner for scanning a financial card to read information therefrom; and
a digital mobile phone coupled to the card scanner for receiving information from the scanner, and transmitting said information, as digital data, to a remote financial authority, said digital phone also receiving, as digital data, information from the remote financial authority.

2. A system according to claim 1, wherein the digital mobile phone also transmits information to the card scanner.

3. A system according to claim 1, wherein:
the digital mobile phone includes an encryption circuit to encrypt data; and
the information transmitted to the remote authority is encrypted digital data.

4. A system according to claim 3, wherein:
the mobile phone further includes a decryption circuit;
information received by the mobile phone from the financial authority is encrypted information; and
the decryption circuit decrypts the encrypted information received from the financial authority.

5. A system according to claim 1, wherein the card scanner and the mobile phone are connected together by a cable, and the cable conducts information between the card scanner and the mobile phone.

6. A system according to claim 1, wherein information is conducted between the card scanner and the mobile phone via wireless transmission.

7. A system according to claim 1, wherein:
the mobile phone includes an analog-to digital converter;
information received by the mobile phone from the card scanner is analog information; and
the analog-to-digital converter converts said analog information to digital data.

8. A system according to claim 7, wherein the analog-to-digital converter converts digital data, received by the mobile phone from the financial authority, to analog signals for transmission to the card scanner.

9. A method of transmitting information about a financial transaction, comprising the steps:
using a mobile financial card scanner to scan a financial card and to read information therefrom;
transmitting the information from the card scanner to a digital mobile phone; and
using the digital phone to transmit said information, as digital data, over a wireless digital network, to a remote financial authority.

10. A method according to claim 9, further comprising the step of using the digital mobile phone also to transmits information to the card scanner.

11. A method according to claim 9, further comprising the step of using the digital mobile phone to encrypt information; and wherein the step of using the digital mobile phone to transmit information to the remote authority includes the step of using the digital mobile phone to transmit encrypted information to the remote authority.

12. A method according to claim 9, wherein:
the step of transmitting information to the digital mobile phone from the financial authority includes the step of transmitting encrypted information to the mobile phone from the financial authority; and
the method further comprises the step of using the digital mobile phone to decrypt the encrypted information received from the remote authority.

13. A method according to claim 9, wherein the card scanner and the mobile phone are connected together by a cable, and the step of transmitting information from the card scanner to the mobile phone includes the step of transmitting said information over said cable.

14. A method according to claim 9, wherein the step of transmitting information from the card scanner to the mobile phone includes the step of transmitting said information from the card scanner to the mobile phone via wireless transmission.

15. A method according to claim 9, wherein:
the mobile phone includes an analog-to digital converter;
information received by the mobile phone from the card scanner is analog information; and
the analog-to-digital converter converts said analog information to digital data.

16. A method according to claim 15, wherein the analog-to-digital converter converts digital data, received by the mobile phone from the financial authority, to analog signals for transmission to the card scanner.
